(19) United States
(12) Patent Application Publication
(10) Pub. No.: US 2013/0219333 A1
(43) Pub. Date: Aug. 22, 2013

(54) Extensible Framework for Facilitating Interaction with Devices

(71) Applicants: Ganesh Palwe, Maharashtra (IN); Debashish Paul, Bangalore (IN)

(72) Inventors: Ganesh Palwe, Maharashtra (IN); Debashish Paul, Bangalore (IN)

(73) Assignee: Adobe Systems Incorporated, San Jose, CA (US)

(21) Appl. No.: 12/483,583

(22) Filed: Jun. 12, 2009

(51) Int. Cl. G06F 3/048

(52) U.S. Cl. 715/810

(57) ABSTRACT

Embodiments include a method of providing an assistant application that identifies a plurality of applications available to a device and receiving, via the device, natural language input. The natural language input can be evaluated to identify a subset of the plurality of applications in order to provide output comprising one or more suggested commands. Each suggested command can correspond to one of the subset of identified applications. In response to selection of a suggested command, the corresponding application can be invoked. Prior to invoking the application, the context for invoking the application and/or the context of the input may be evaluated in order to determine one or more parameters associated with the application. The natural language input can be used to suggest commands that include one or more suggested parameter values to pass to when invoking the application. Similar techniques can be used for accessing data services.

### TECHNICAL FIELD

The disclosure below generally relates to user interfaces, particularly to natural language interfaces for computing devices.

### BACKGROUND

Computing devices can present challenges for developers and users due to the small size of the devices in view of ever-increasing complexity in available functionality for the devices. For example, a cellular telephone, personal digital assistant (PDA), or other device may include a relatively small screen area with few or no buttons and a limited or no capability for point-and-click or other gesture-based commands. Instead, a user may interact with the device by selecting a plurality of commands nested into levels.

For example, a user may provide a first command to obtain a set of available applications, and may dig through one or more levels to locate a desired application via second and third commands (e.g. Home->Applications->E-mail). Within that application, the user may need to provide still further fourth and fifth commands to select an option to send a message and then enter parameters (e.g., an address and subject in an email message).

Each time a particular application or component is required, the appropriate sequence of commands may be needed. This may rapidly become tedious, for example, in the case of a multitasking user. A first sequence of commands may be needed to locate an address and place a telephone call. During the telephone call, if the user desires to view a web site, a second sequence of commands may be needed. If the user wishes to email data from the website, a third sequence of commands may be needed. The issue may be compounded when the user switches to a different device and finds that the series of commands for a given application or task (e.g., send email) may vary between different devices.

### SUMMARY

One or more aspects of the present subject matter can be used to provide an assistant application that provides a user interface that can allow a user of a computing device to utilize advanced features of the device without requiring excessively complex navigation or input.

Embodiments include a method of providing an assistant application that identifies a plurality of resources, such as applications, available at or to a device and receives, via the device, natural language input. The natural language input can be evaluated to identify a subset of the plurality of applications in order to provide output comprising one or more suggested commands. Each suggested command can correspond to one of the subset of identified applications. In response to selection of a suggested command, the corresponding application can be invoked. For instance, the application may be executed locally, accessed for execution at a remote resource, or downloaded from the remote resource.

In some embodiments, prior to invoking the application, the context for invoking the application and/or the context of the input is evaluated in order to determine one or more parameters associated with the application. The natural language input can be used to suggest commands that include one or more suggested parameter values to pass to when invoking the application.

Embodiments also include providing a list of suggested data services and providing a preview of a selected data service. The list of data services can be generated based on natural language input and one or more parameter values to pass to the data service may be suggested based on the context of natural language input and/or the context for the data service.

Embodiments also include devices, such as mobile and other devices, and computer-readable media comprising program code for implementing one or more aspects of the present subject matter.

These illustrative embodiments are mentioned not to limit or define the limits of the present subject matter, but to provide examples to aid understanding thereof. Illustrative embodiments are discussed in the Detailed Description, and further description is provided there. Advantages offered by various embodiments may be further understood by examining this specification and/or by practicing one or more embodiments of the claimed subject matter.

### BRIEF DESCRIPTION OF THE DRAWINGS

A full and enabling disclosure is set forth more particularly in the remainder of the specification. The specification makes reference to the following appended figures.

FIG. 1 is a block diagram illustrating an exemplary telecommunications system.

FIG. 2 is a block diagram illustrating an exemplary architecture for a mobile terminal.

FIG. 3 is a block diagram illustrating an exemplary architecture of a mobile assistant.

FIG. 4 is a flowchart showing an exemplary program flow for a mobile assistant.

FIG. 5 is a diagram illustrating an example user interface for a mobile terminal.

FIG. 6 shows an example of a program flow for suggesting commands.

FIGS. 7A-7C illustrate an example user interface during different portions of a flow for suggesting commands.

FIG. 8 is a flowchart for suggesting commands and one or more parameters based on evaluating the context of input.

FIGS. 9A-9D illustrate an example of a user interface during different stages of a program flow that suggests commands and parameters

FIG. 10 is an example illustrating a program flow for defining and/or using custom definitions.

FIGS. 11A-11D illustrate an example of interface activity during a program flow for defining a custom definition.

FIG. 12 is a flowchart for providing a data services interface.

FIGS. 13A-13C illustrate an example of user interface activity when a data services interface of a mobile assistant is utilized.

FIG. 14 is a block diagram illustrating an example of a computing device that can be configured to utilize an assistant configured in accordance with one or more aspects of the present subject matter.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure the claimed subject matter.

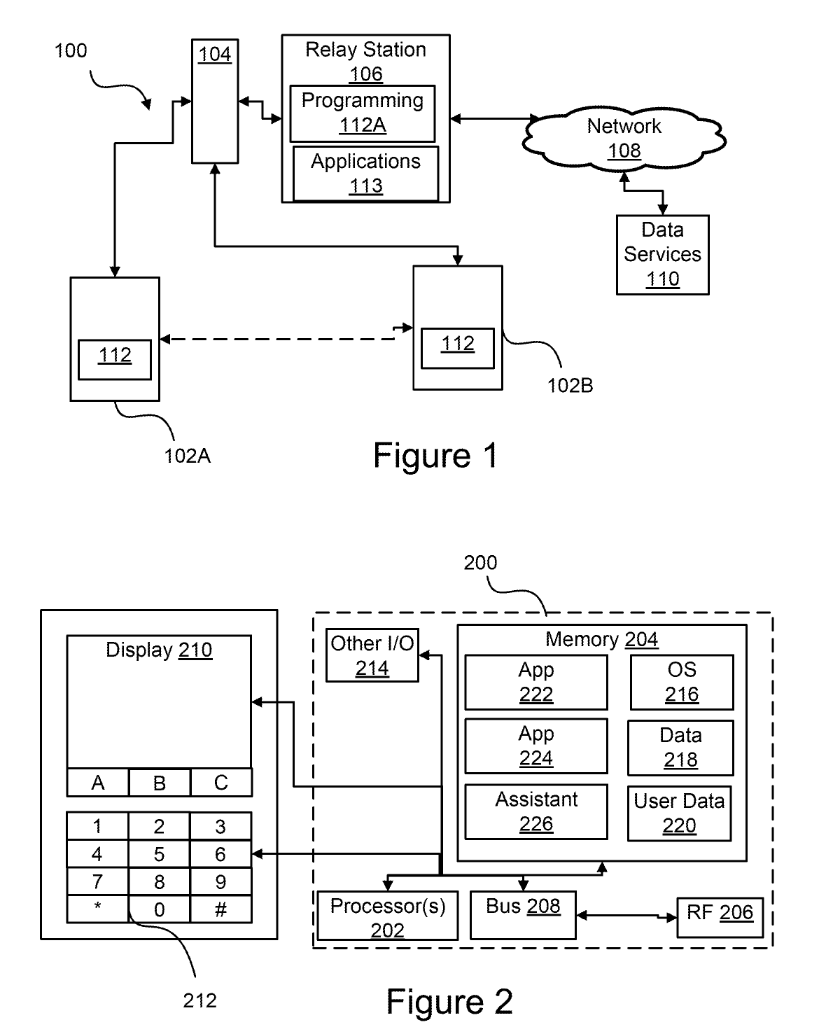

FIG. 1 is a block diagram illustrating an exemplary telecommunications system 100. In this example, a plurality of mobile terminals 102A and 102B are in wireless communication with a node of a wireless network comprising a radio frequency (RF) transmitter/receiver 104 and relay station 106. For example, RF transmitter/receiver 104 and relay station 106 may comprise a base station in a wireless network such as a cellular telephone network or wireless internet service provider. As indicated by the dotted lines, mobile terminals 102 may be in direct or indirect communication with one another by other suitable links.

In this example, relay station 106 is connected to another network 108, e.g. a local area network or wide area network (such as the internet), which is linked to one or more data service providers 110. Data service provider 110 represents any number or type of provider of data over a network. For example, a data service provider 110 may utilize one or more computing systems (e.g., web servers, email servers, and databases) to provide data upon request and/or without request, such as using “push” technology.

At least some mobile terminals 102 of telecommunication system 100 are configured by programming 112 to provide a mobile assistant configured in accordance with one or more aspects of the present subject matter. For example, as noted below, programming 112 can comprise one or more applications, processes, or components embodied in memory of mobile terminal 102 that provide a mobile assistant for use in navigating available options provided by other components of mobile terminal 102.

In addition to or instead of providing the functionality via a mobile terminal 102, suitable programming may be included elsewhere in the telecommunications system. For example, as shown by 112A, programming can be included in one or more computing devices comprising relay station 106 to provide some or all aspects of the mobile assistant, with mobile terminal 102 comprising a hardware platform for receiving input and providing output. As another example, one or more data service providers 110 can configure its hardware and/or software to provide mobile assistant functionality. Even when mobile assistant functionality is provided locally at the mobile device, relay station 106 and/or data service providers 110 can include components to support mobile assistant functionality (e.g., lists or data feeds of keywords and parameters for use in identifying available applications/data services for download or subscription).

In this example, one or more computing devices or relay station 106 include applications 113. For example, if telecommunications network 100 comprises a cellular telephone network, applications 113 may be available for download for execution at a mobile terminal 102 in exchange for a payment and/or subscription commitment by a user associated with the mobile terminal. Applications 113 may additionally or alternatively be provided by other entities (e.g. data service provider 110) with access to telecommunications network 100. As a further example, applications 113 may represent applications that are remotely hosted but accessible via a mobile terminal 102 in exchange for payment and/or a subscription commitment.

FIG. 2 is a block diagram illustrating an exemplary architecture 200 for a mobile terminal 102. In this example, mobile terminal 102 includes one or more processors 202 and memory 204. Memory 204 can comprise one or more computer-readable media accessible by processor(s) 202 that embodies program components and data structures used by processor(s) 202 to provide desired functionality for mobile terminal 102.

Processor 202 is linked via bus 208 to data and user interface I/O components. In this example, the user I/O components include a screen 210 of mobile terminal 102. For example, an LED, LCD, or other suitable display technology may be provided to provide visual output. Keypad 212 can be used to provide input to mobile terminal 102. In this example, a 12-digit keypad is provided along with three function keys A, B, and C. However, it will be understood that the particular I/O capabilities of mobile terminals can vary. For example, a mobile terminal may include more function keys on various surfaces of the mobile terminal, multiple displays, and/or a full keyboard in some embodiments. As another example, in addition to or instead of a keypad, mobile terminal 102 may comprise a touch-enabled display that can sense one or more touches via capacitive, optical, or other touch sensing techniques.

Other I/O 214 is included to represent additional components of mobile terminal and may include, for example, a nicrophone/speaker interface for receiving and providing audio to a user of the mobile terminal, image sensors (e.g., CCD array for an onboard camera), one or more data interfaces (e.g., USB, mini-USB, SIM card reader), and other I/O components (e.g. actuators for providing a “vibrate” function).

Mobile terminal includes one or more RF interfaces 206 for receiving and transmitting data via one or more wireless links. For example, if mobile terminal 102 comprises a cellular telephone, RF interface 206 can include a transmitter/receiver assembly and appropriate signal processing components in order to establish a link via CDMA, GSM, and/or other cellular telephone communication standards. As another example, mobile terminal 102 may support wireless communication via IEEE 802.11 links in addition to or instead of cellular links.

Memory 204 can be provided via onboard RAM, FLASH memory, and/or via storage devices (e.g., PCMIA, SIM cards) accessible by processor 202 in some embodiments. As was noted above, the memory can embody program components and data structures for use in operating mobile terminal 102. For instance, mobile terminal 102 may include an operating system 216, operating parameters 218, and user data 220. Operating system 216 may comprise, for instance, a “thin” operating system specific to the particular hardware of mobile terminal 102.

Operating parameters 218 can include data for enabling operation within one or more telecommunication systems, such as host routing tables, subscriber identity information, encryption keys, device identifier data, and the like. User data 220 can comprise contacts (names, addresses, telephone numbers), data stored by other applications on mobile terminal 102, and any other data stored at the mobile terminal.

In this example, memory 204 further comprises applications 222 and 224. For example, mobile terminal 102 may include any number of applications including, but not limited to, an email application, a web browser, photo capture/browsing software, text messaging software, call control software for initiating and receiving telephone calls, calendar software, and/or one or more applications for specific data services provided by one or more data service providers 110 (e.g., software for interfacing with a mapping service, photo sharing service, social networking service, etc.). Applications such as 222 and 224 may maintain data locally at mobile terminal 102 (e.g., as user data 220) and/or may rely on data provided from one or more data service providers 110. For example, address book information may be maintained locally while calendar and email data may be synchronized from a data service provider.

In some embodiments, memory 204 further embodies one or more program components that provide a mobile assistant 226 in accordance with aspects of the present subject matter. For instance, use of a mobile assistant may simplify use of mobile terminal 102 and enhance a user's overall experience. As an example, in situations where operating system 216 provides a menu-driven user interface via display screen 210, the mobile assistant may provide a more user-friendly alternative.

In some embodiments, mobile assistant 226 is configured as an application running atop the operating system of mobile terminal 102. Particularly, mobile assistant 226 may execute as a standalone application or may execute via a runtime environment that is itself executed as a standalone application in the operating system of mobile terminal 102. As an example, the runtime environment may comprise Adobe Flash Lite®, available from Adobe Systems Inc. of San Jose, Calif. In some embodiments, the functionality of the assistant can be integrated into the operating system of a device.

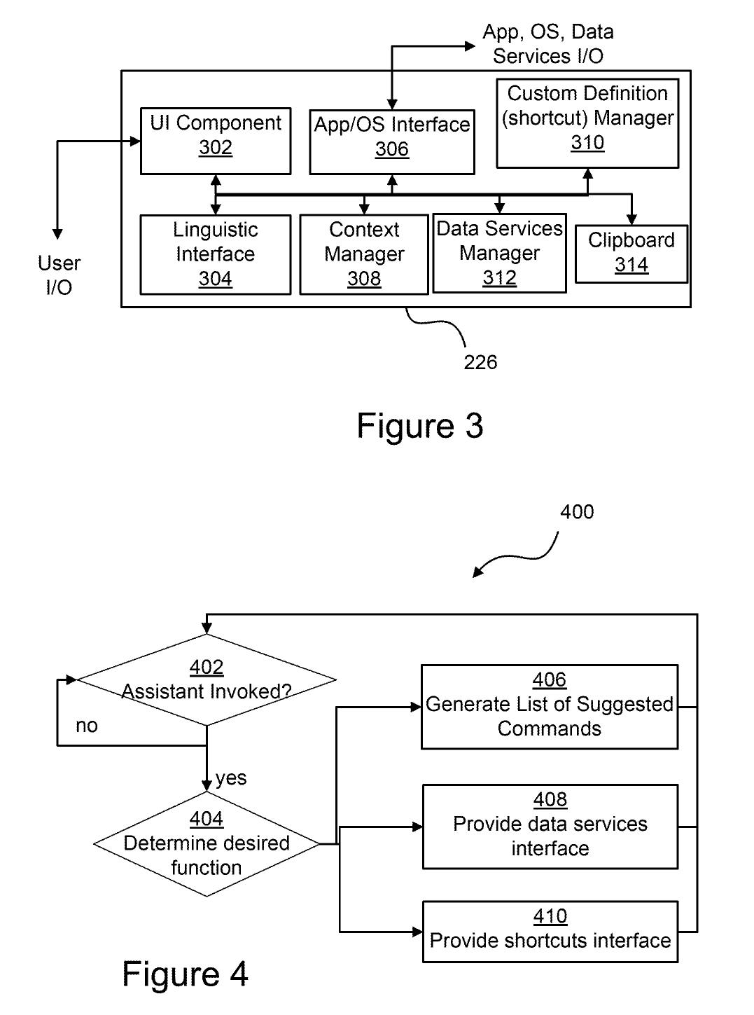

FIG. 3 is a block diagram illustrating an exemplary architecture of a mobile assistant 226. In this example, mobile assistant 226 comprises several components that provide an extensible framework for interacting with applications and data services available to a mobile device.

For instance, mobile assistant 226 can include user interface (UI) component 302 that is used to receive input and provide output to one or more users of the mobile device. As an example, UI component 302 may handle the details of generating suitable visual, audio, tactile, and/or other output and receiving data via hardware components of the mobile device.

A linguistic interface 304 can be provided in order to allow commands, parameters, settings, and other data to be provided using a natural-language format, rather than via a series of navigation commands. For example, a user may provide text commands via UI component 302 that are recognized via linguistic interface 304 by identifying a desired application, task, data service, and/or parameters as the input is presented. For instance, the application/task may be specified using a subject-predicate context such as “send email,” with “email” triggering selection of an email application and “send” triggering use of the “send” task. The linguistic interface may recognize different commands referring to the same task—for example, “email” entered alone may also trigger selection of the email application.

Although the above example discussed user input received as text, UI component 302 and linguistic interface 304 may receive other input—for example, UI component 302 may perform speech recognition analysis on spoken commands from a user and provide a string of text or other indicator of the input to the remaining components of assistant 226.

Application/OS interface 306 can be used by mobile assistant 226 to send appropriate commands and data to the operating system, applications on the mobile device, and/or other resources at or available to the device. For example, once a desired task is identified, application/OS interface 306 can provide suitable commands based on the APIs for the applications and/or the OS of the mobile device in which mobile assistant 226 is operating to implement the task. Returning to the example above, a user may be presented a list of one or more potential actions, including “send email” based on natural language input. Upon selection of the “send email,” the email application can be launched via a launch command provided to the OS. As another example, interface 306 may also provide data to and receive data from one or more data services.

Context manager 308 can be used alongside linguistic interface 304 to provide a more intelligent response to user input by considering the particular context in which a command is specified. Generally, context manager 308 can consider the current context in which the mobile assistant has been triggered, with the current context referring to a particular interface view or state, along with the linguistic context of the user input. The current context may refer to a specific application, for instance, or even a particular field in a particular input screen in the specific application.

For example, if a user inputs “send email” after triggering the mobile assistant from the “home” screen of the mobile device, the mobile assistant may switch the user's context to a mail application to compose a new email. If the same command is provided within the application, the email currently being composed can be sent.

Context manager 308 may be used in generating the list of commands for a user to select based on input received via UI 302 and linguistic interface 304. For example, context manager 308 may recognize that “send email” is a command to trigger use of the “send” command for an email application based on the linguistic context. Since the command is being provided in the context of an email message, context manager 308 can access data related to the email application in order to generate a list of potential commands or parameters related to the email application. For instance, as will be noted below, in the context of a “send email” command, context manager 308 may provide a list of contacts by accessing user data, such as an address book.

Context manager 308 additionally or alternatively may access resources from outside the mobile terminal. For example, if the mobile terminal has access to address book information provided via a data service, addresses available from the data service may be included. Another example of context is contents of a clipboard available at the device, such as from clipboard manager 314 discussed below. The contents of the clipboard may be evaluated against potential commands and the clipboard contents may be included as suggested parameters.

Custom definition manager 310 can be used to record and play back sequences of commands (“shortcuts) provided to a mobile device in a conventional manner and/or via other components of mobile assistant 226. For example, a user may record a sequence of navigations for a commonly-used task such as resetting the current time or time zone for the device and associate the recorded sequence with a shortcut command or hotkey. Custom definition manager 310 can recognize the shortcut or hotkey and playback the recorded sequence, thereby allowing a user to avoid having to enter the sequence again and again. Custom definition manager 310 can be configured to export recorded sequences to allow shortcuts to be shared and/or may be configured to import recorded sequences. For example, a first mobile user may share a shortcut with a second mobile user, with the respective custom definition managers exporting and importing the recorded sequence corresponding to the shortcut. As another example, custom definition manager 310 can browse available shortcuts from a remote resource (e.g., network service provider, data service provider, application provider, etc.).

Data services manager 312 can be used to provide a simplified interface for interacting with data services available to the mobile device. For example, in some embodiments, data services manager 312 can provide a list of available data services at the device in response to use input received via UI 302/linguistic interface 304. Data services manager 312 can also provide contextual data for use by context manager 308 in generating selectable commands and parameters when a data service is to be invoked.

In some embodiments, data services manager also provides a UI component previewing the information from a selected data service in order to spare the user from navigating to a separate application. For instance, a user may have access to a weather data service ordinarily accessible via a browser application or an application specifically designed for accessing the weather service. Data services manager 312 can access user and other data to determine that the weather service is available at the mobile device. When mobile assistant 226 is invoked, the weather service may appear in a list of available services and, when selected, data from the weather service can appear in a preview window provided by data services manager 312. The preview window may, for example, include browser functionality or other UI components (e.g. text boxes, maps, video playback components) to display some or all data from the selected service.

In some embodiments mobile assistant 226 further includes clipboard component 314 for passing data between applications, data services, and/or other resources. For example, mobile assistant 226 can maintain a memory space for storing text, images, or other data identified by a user via a “6copy” command in a first context. In some embodiments, upon receipt of a copy command, the entire contents of the preview screen for data services can be copied into memory by clipboard component 314 for use in other contexts. Upon receipt of a “paste” command in a second context, the data stored in the memory space can be supplied as an input to a selected field in the second context or otherwise utilized (e.g., sent as an email attachment, included in a blog posting, etc). In some embodiments, the clipboard can maintain multiple items and present an interface for selecting one or more of the items for pasting when needed.

Although in the example above, mobile assistant 226 included UI component 302, linguistic interface 304, application/OS interface 306, context manager 308, custom definition manager 310, data services manager 312, and clipboard 314, other embodiments may include fewer than all components. For example, an embodiment of a mobile assistant may not include all the functionality discussed above. As another example, the functionality may be provided by a different mix of components.

FIG. 4 is a flowchart showing a method 400 representing an overall program flow for a mobile assistant. For example, in some embodiments, a mobile assistant runs in the background (i.e., with minimal or no UI indication) but can be invoked by a hotkey or command (e.g., by pressing the “*” key, speaking “assistant” into the handset, etc.). Block 402 represents awaiting a command invoking the assistant. At block 404, the assistant determines the desired functionality and branches to the appropriate subflow. In this example, three subflows 406, 408, and 410 are illustrated to show how various tasks can be invoked via the assistant.

Subflow 406 represents providing a list of suggested commands based on natural language or other input provided by a user and executing one or more desired applications. Subflow 408 represents providing a data services interface in response to user input. Subflow 410 represents providing a shortcut interface to define and/or invoke execution of a shortcut. Exemplary methods for carrying out these subflows are discussed later below.

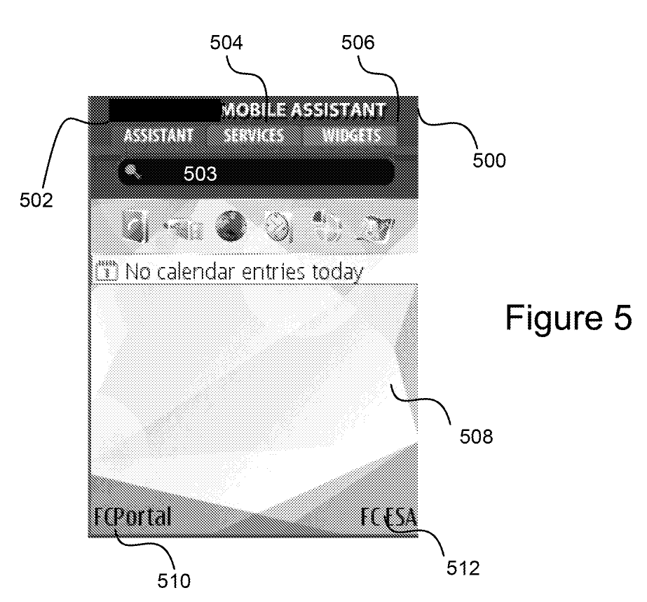

FIG. 5 is a diagram illustrating an example output state of a mobile terminal. In this example, an interface 500 including three tabs 502, 504, and 506 has been overlaid on the home screen 508 of the mobile terminal. Function commands 510 and 512 are also visible; for example, keys adjacent the display may be used to trigger selection of particular commands illustrated at 510 and 512 to begin navigating through potential commands for the device.

However, since a mobile assistant has been invoked, navigating through different menu commands may be simplified. In this example, the “assistant” tab 502 is active and provides a text entry area 503 for receiving user input. As noted above, a user may key, speak, or otherwise provide natural language input for use by the mobile assistant. In this case, tab 502 invokes a program flow for generating a list of suggested commands based on the user's input.

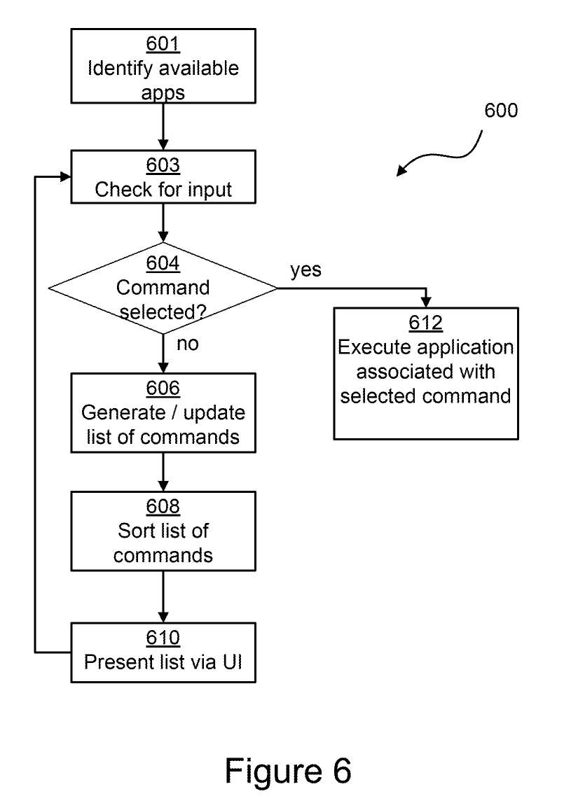

FIG. 6 shows an example of a program flow 600 for suggesting commands. At block 601, data is accessed to determine the applications available to the terminal. Block 603 represents checking for input. For example, UI component 302 can relay textual, spoken, and/or other natural language input in a form that can be recognized by the mobile assistant. If input is received, then at block 604, the natural language (or other) input is evaluated to determine if a command is selected or specified. For example, a user may rapidly input (or speak) a desired command and select the command for quick execution.

If a command is not yet selected, then at block 606 the natural language input (if any) is evaluated to identify a subset of the applications available at the device including at least one application in order to generate a list comprising one or more commands, with each command corresponding to a respective application. If a list has been generated in a previous iteration, the existing list can be updated. If no input is provided for a certain length of time, then the list may contain all applications available to the mobile terminal. At block 608, the list is sorted, and then at block 610 the list is presented via the UI. As indicated by the loop, a user may continue to provide input that is used to update an existing list of commands. For example, the range of suggestions may be narrowed by further input as it is received.

In some embodiments, block 606 generates or updates the list of commands by evaluating the input using linguistic interface 304 to perform natural language analysis on the input. For example, various terms and phrases may be mapped to commands for applications available to the mobile terminal and used to populate the list with suggested commands corresponding to the applications.

In some embodiments, each application at the mobile terminal and/or other resource available to the terminal is associated with one or more keywords that are matched to the natural language input. For example, the keywords may be included in tags in application metadata or embedded in an application itself. Thus, application developers can include suggested keywords so that applications are suggested by the assistant.

In matching natural language input to keywords, the match does not need to be exact—for instance a certain degree of “fuzziness” can be supported, such as expected misspellings. As another example, adaptive algorithms can be used so that, over time, user input can be matched to particular commands, tasks or outcomes. For example, the command “send” may be initially result in a suggestion of email and SMS commands. If a user repeatedly uses only the email command after inputting “send,” the SMS suggested command may be dropped from the list in the future.

The context of natural language input can be parsed to identify both commands and parameters. For example, the natural language input “Get movie reviews of Movie X” can be parsed to suggest a movie application/online data service based on the word “movie” or the phrase “movie review.” The term “of” can be recognized as preceding a subject of the sentence so “Movie X” can be included as a parameter sent to the application/data service. For the particular case of the movie application/data service, “of” may be assumed to refer to a movie title, while “at” may be assumed to refer to a time or location. For example, “movies at Location Y” may be parsed to identify the same service but pass a parameter “location=Location X” to receive a listing of movies at the particular location.

In some embodiments, the listed applications may include applications not currently stored at the mobile terminal, but which are available from an application provider. For example, a data service provider 110 and/or a telecommunications provider (e.g., cellular service provider, wireless internet service provider, etc.) that provides communication network 100 may allow users to purchase or otherwise download applications on demand as noted above. These applications may have associated keywords or other metadata accessible to the mobile assistant for use in generating a list of suggested commands. For example, relay station 108 and/or a data service provider 110 may provide a listing of keywords or other metadata to the mobile assistant in response to a query from the mobile assistant for potential commands to provide to a user or push such data to the mobile assistant for ready use when needed.

Once a command is selected, then the mobile assistant can invoke the application of interest—e.g., the assistant can cause the application to provide output and/or receive input at the device. In this example, block 612 represents executing the application associated with the selected command. If the application is already executing (e.g., in the background), then the mobile terminal's current context can be switched to the application.

If the application is remotely hosted or is available for download, block 612 can comprise sending a request for access to the application from a remote resource (e.g., relay station 110 in FIG. 1). If payment or a subscription is required to access a resource such as an application, the mobile assistant can access appropriate user credentials to authenticate the request; before doing so, the mobile assistant may prompt the user to confirm the course of action before committing the user to payment or a subscription.

In the example above, suggested commands were mapped to applications executable via the mobile terminal. In some embodiments, the suggested list of commands can include a command corresponding to another resource available at or available to the mobile terminal other than executing or accessing an application. For instance, as will be discussed later below, a user can define shortcuts that playback a series of input commands to automate tasks on the mobile terminal and the shortcuts can be included among the suggested commands.

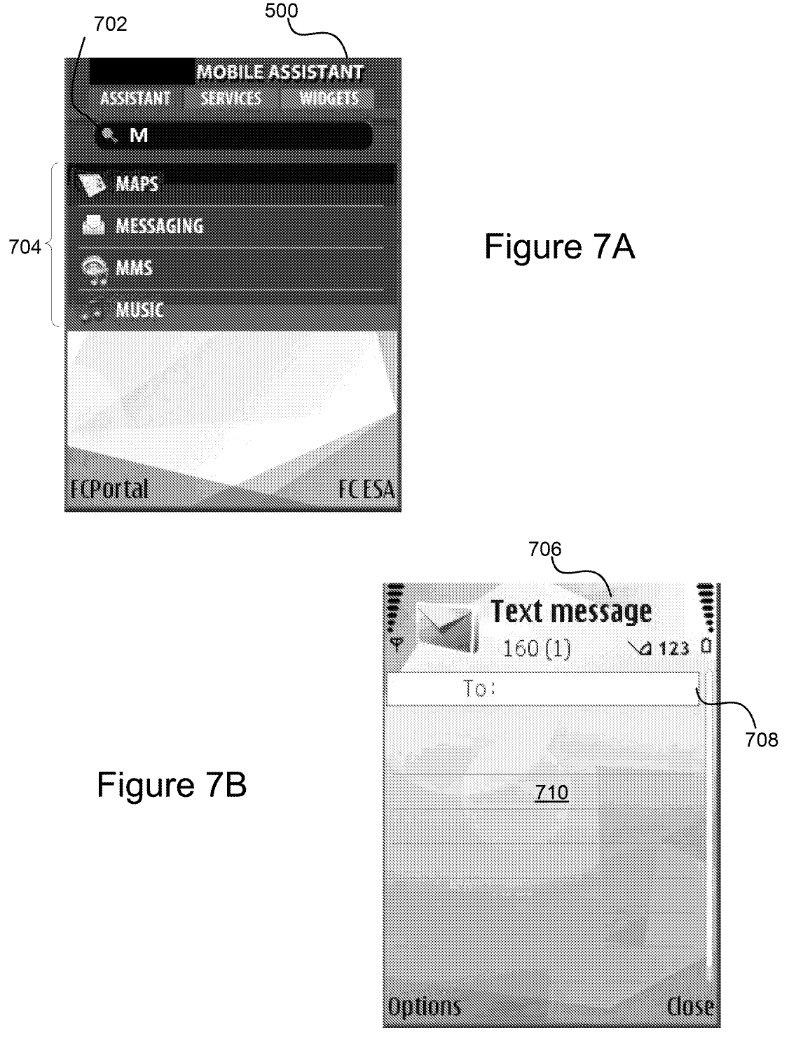

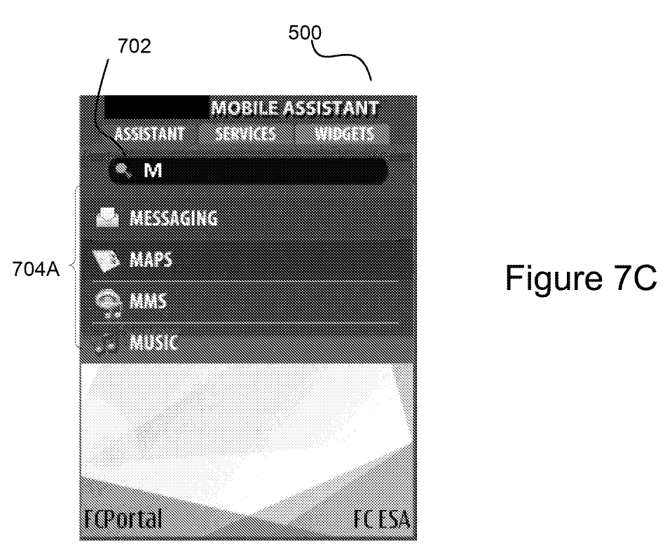

FIG. 7A illustrates an example of interface 500 including user input 702 (“M”) and a resulting list 704 of suggested commands. In this example, the input “m” has been mapped to four potential commands “Maps,” “Messaging,” “MMS,” and “Music.” Once presented with this list, the user may scroll to or otherwise select one of the available commands. If so, program flow 600 will proceed to block 612 to execute the application with the command. Alternatively, the user may continue providing input. For instance, if the user types “E,” then based on the input “Me” the list may be updated to include only “messaging.”

Once a command is selected, the mobile assistant takes action to implement the desired command. For instance, one or more applications of the mobile terminal can be invoked. Turning to FIG. 7B, an interface 706 is illustrated showing that the context of the mobile terminal has changed to a Text Messaging command. This may be a result of a user's selection of the “Messaging” command from FIG. 7A. As shown in FIG. 7B, the user may now enter one or more recipients in field 708 and a message body in field 710.

In some embodiments, metadata on use of the mobile assistant is maintained to improve its performance. For example, selection of a command from a list of suggested commands produced from a given set of input can be used to improve the response of the mobile assistant when future input is provided. For example, linguistic interface 304 and app/OS interface 306 may be used to associate the input of “m” and subsequent use of the Text messaging application.

This and other metadata can be used in determining which commands are suggested and how the commands are suggested. For example, as shown in FIG. 7C, the next time that a user enters “M” into field 702, a list 704A is presented. In this example, the same commands are suggested, but sorting block 608 has ordered the commands differently. Particularly, the “messaging” command is at the top of the list due to the metadata indicating that the last time “M” was provided, the desired command was “Messaging.” This effect can be achieved in any suitable way. For example, a given input string can be associated with a list of commands, with the commands weighted based on previous selection activity that occurred when the input was specified.

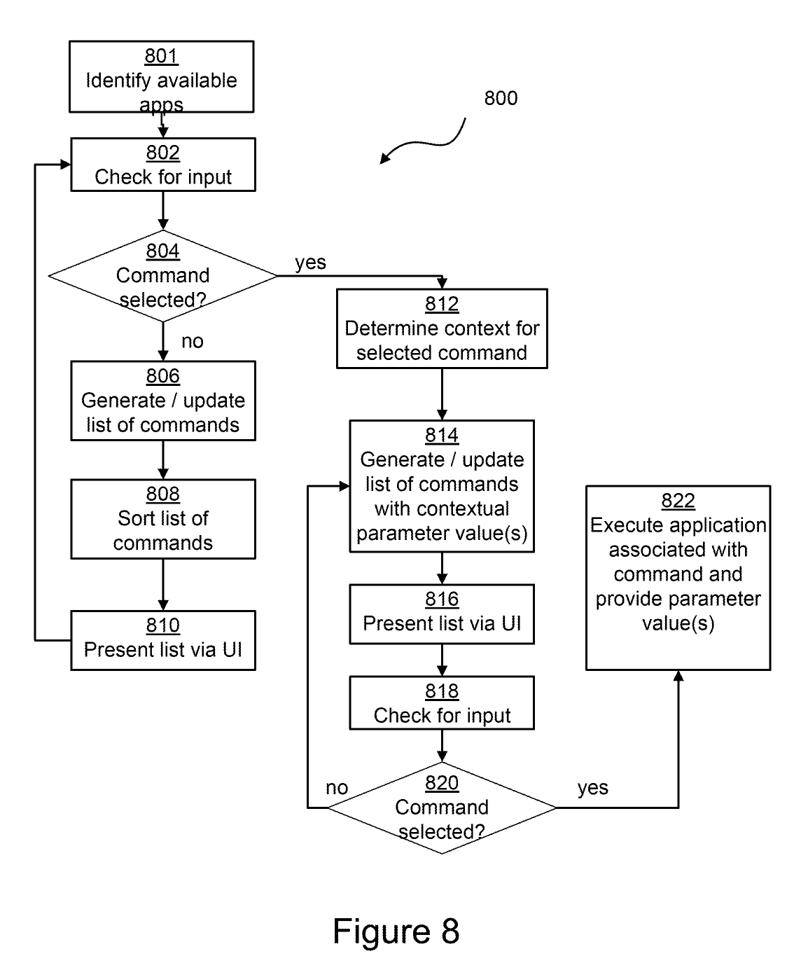

As was mentioned above, a mobile assistant can evaluate the context of user input in generating a list of suggested commands. For example, FIG. 8 illustrates an exemplary program flow for generating a list of commands and a list of commands including contextual parameters.

Beginning at block 801, the applications available to the mobile terminal are identified and at block 802 the method checks for input. Block 804 represents entering a loop if a command is not selected, namely generating or updating a list of commands at block 806, either in response to natural language input or including commands corresponding to all available applications. The list of commands is sorted at block 808 and presented via the UI at block 810. The method returns to block 802 to await further input as was discussed above with FIG. 6.

In this example, however, further activity occurs between a selection of a command and invoking an application associated with the command. Particularly, the mobile assistant can be configured to recognize selection of a command that indicates a desire by the user for further suggestion. This may be indicated by particular syntax—for instance, pressing “enter” or “send” within a list of suggested commands may indicate a desire to go directly to an application, while entering a “space” or otherwise continuing to provide input even after only a single command is suggested may be recognized as a selection of the command subject to additional suggestions.

Once a suitable indication is received, the context of the input is evaluated to determine parameter values to suggest alongside the command as shown at 812. For example, context manager 308 can identify an application associated with the selected command and determine one or more parameters associated with the application. For instance, each application may have a listing of available parameters as part of an API for the application.

Based on parameters expected for the application, data representing potential parameter values can be accessed from the device (and/or other resources) and used to generate or update a list of commands with contextual parameter values as shown at block 814. In a manner similar to producing/updating the list of selectable commands, the list can be sorted based on metadata regarding frequently-used parameter values for the command.

For example, assume the user enters a messaging command (e.g., “message 555”). The “message” command can be recognized as including a telephone number parameter and the user's address book can be searched for numbers starting with, or including, 555. If the user frequently enters a particular telephone number 555-1212, or previously selected 555-1212 from a list of several commands with parameter values, the most frequently-used number may be listed at the top even if other numbers potentially match the input.

In some embodiments, the contents maintained by clipboard component 314 can be considered for use as parameters. For example, a user browsing the web may select a line of text and copy it to the clipboard. If the user triggers the mobile assistant and inputs “email,” the recommendation list may include a suggested “subject” parameter with the text from the clipboard. If the copied text is an email address or name, the email address or name may be included as a suggested “to” parameter. As another example, if the user triggers the mobile assistant and inputs “translate,” the copied text may be suggested as an input to a translation application or data service.

At block 816, the list is presented via the UI, and at block 818, the method checks to see if further input is received. At block 820, the further input is evaluated—for example, the further input may comprise natural language input to be used by the mobile assistant to narrow down the list of commands with contextual parameters if no command is selected.

At block 822, if a command is selected, then the mobile assistant invokes the application associated with the command. For example, the assistant may execute or switch the context of the device to the application associated with the command, including passing one or more parameters to the application. This may further enhance the user's experience by reducing or eliminating the need to navigate within an application.

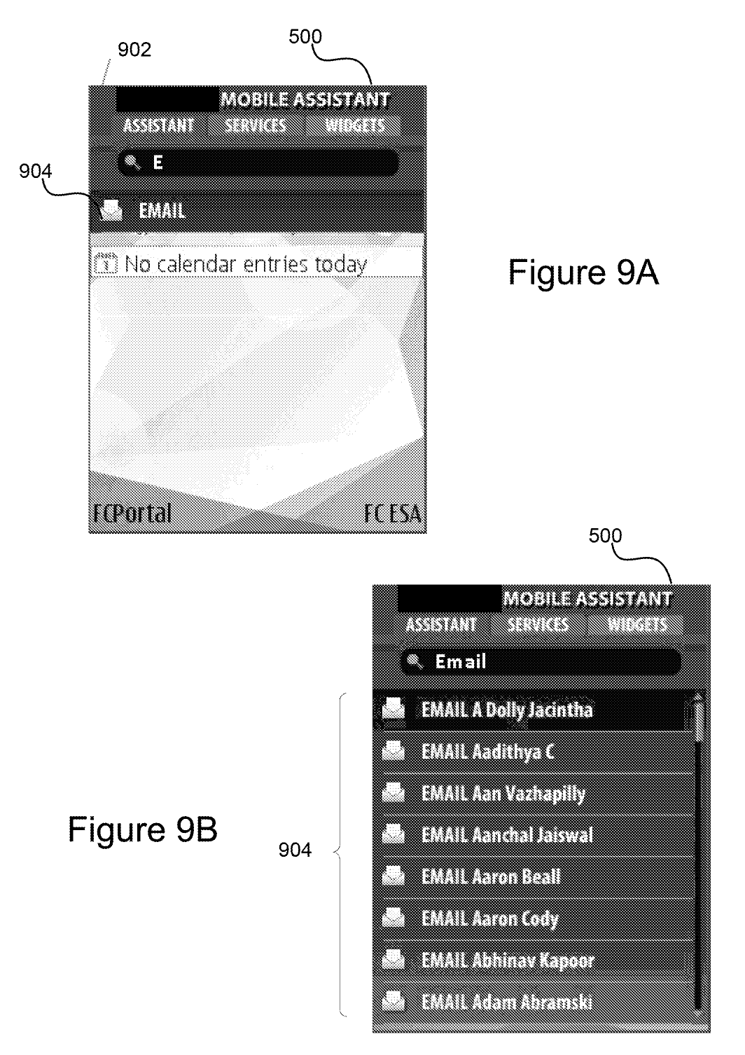

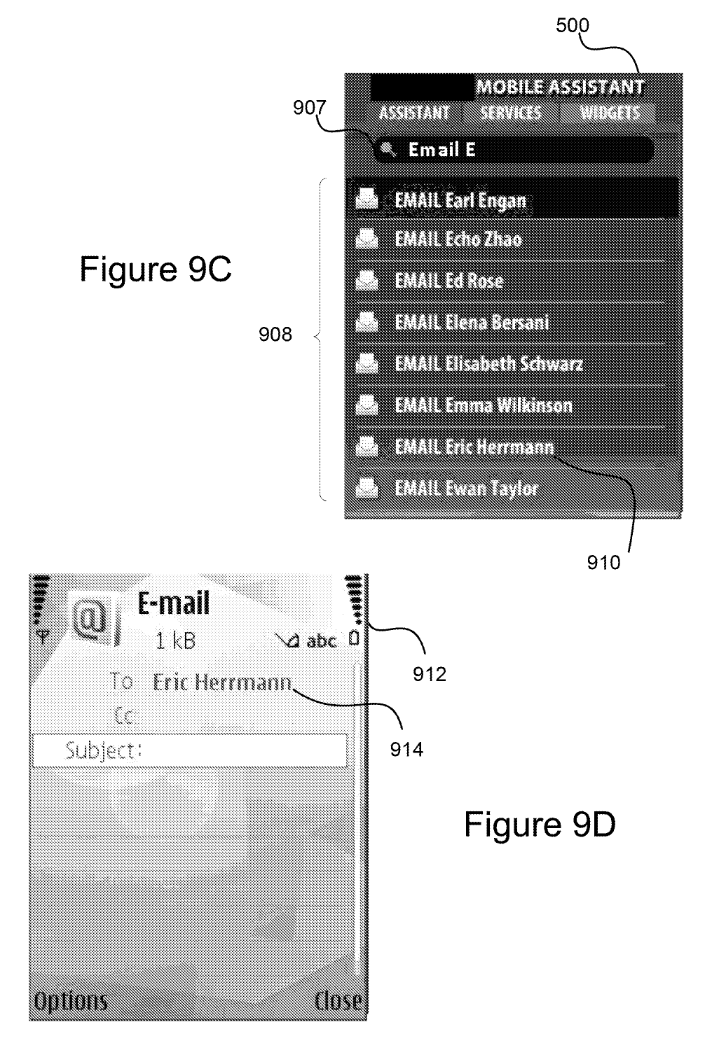

FIGS. 9A-9D illustrate an example of a user interface 500 during different stages of a program flow that suggests commands and parameter values. In FIG. 9A, interface 500 includes assistant tab 902 of the mobile assistant. In this example, a user has already provided input “E” that has resulted in a list suggesting a single application “Email.” As was noted above, a user may simply provide input to select the “Email” command alone (e.g., pushing a particular key such as “send” or enter”) and proceed directly to the email application.

In this example, the user provides input that indicates a suggested list of parameters is desired. For example, the user may enter “email” completely followed by a “space.” As another example, the user may select the “email” command but using a key other than the key (“enter” in the example above) that goes directly to the application. In any event, contextual monitor 308 recognizes that an “email” command is desired and accesses appropriate parameters associated with the “email” application.

In this example, a list of email addresses is accessed, such as from the user's address book or other data stored at the mobile terminal. As another example, the addresses could be accessed by querying a data service that provides some or all of the address book data. As shown in FIG. 9B, the email addresses appear in a list 904 of commands with contextual parameters.

In FIG. 9C, the user has provided additional input rather than selecting one of the commands with contextual parameters. Particularly, the user has entered “E” after “Email,” which has led to an updated list 908 containing names with a first or last name starting with “E.”

The user may continue to enter text or may navigate to entry 910 to indicate that “Eric Herrmann” is the desired recipient and then provide input selecting the command “Email Eric Herrmann.” After the command with parameter is selected, the mobile assistant invokes the email application, including passing an “address” parameter to the application. As shown in FIG. 9D, the email application 912 appears at the user interface with “Eric Herrmann” included in the address field 914. The user can then proceed to compose an email message.

In this example, a single parameter was passed to the desired application. However, embodiments can support multiple parameters in a command. For example, the user may provide input selecting “Email Eric Hermann” and then proceed to type “S.” Based on the context of a command specifying email+an address+“s,” the context monitor 308 may determine that the user wishes to enter a subject. The suggested commands may include “Email Eric Hermann Subject:” and may even suggest subject lines based on accessing subjects for other emails to/from Eric Hermann and/or others.

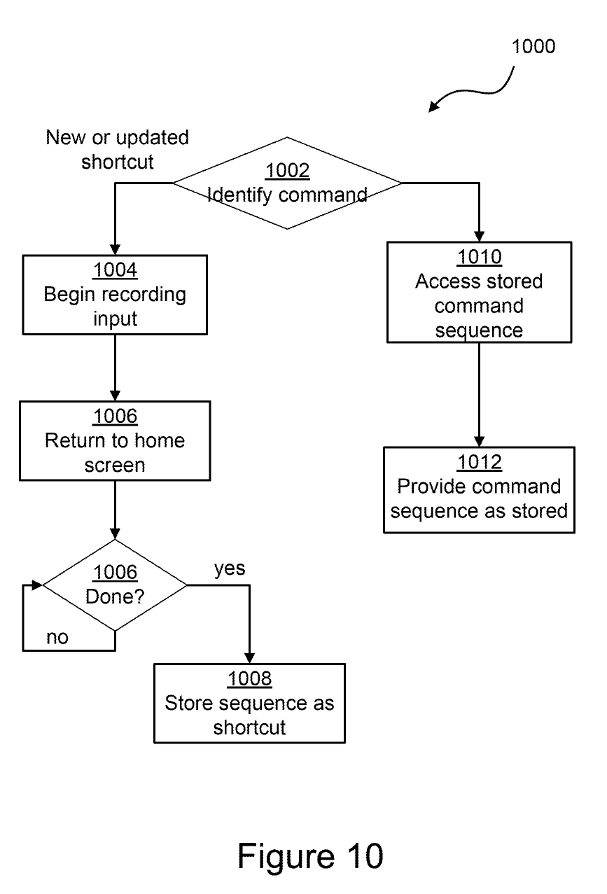

Some embodiments of a mobile assistant application may include a custom definition manager 310 for defining shortcuts as noted above. FIG. 10 is an example illustrating a program flow 1000 for defining and/or using custom definitions. At block 1002, the particular custom definition command is identified. If a new or updated shortcut is to be specified, flow branches to block 1004 at which the custom definition manager 310 begins recording input. At block 1006, the current context is returned to the device's home screen, although shortcuts could be defined relative to another starting point.

Block 1006 represents recording user input until the desired task is accomplished or recording is otherwise terminated. Termination can be indicated by use of a suitable command such as a combination of keys, key press for an extended period of time, or another suitable type of input that would not be required as part of a shortcut. Until recording is complete, the user's input can be stored, in sequence, so that the input can be recreated on demand when the shortcut is utilized. For example, a user may perform several conventional navigation actions (e.g., selecting an “applications” menu, moving to a sub-menu for a particular application, and moving to different fields of the application) and provide input to various fields, with both the navigation actions and input recorded. The timing of the commands, such as delays between navigation actions or key presses can be stored in some embodiments in order to recreate the input with high fidelity.

Once the user indicates that recording is complete, then at block 1008 the sequence is stored as a shortcut. For example, the context can be switched back to the custom definition screen and the user can be provided an opportunity to define a name and/or command for invoking the shortcut. When the custom definition manager is invoked later, then program flow can branch from block 1002 to block 1010. The stored sequence can be played back to recreate the user's input at block 1012. If timing data is available, the original timing may be maintained or the command sequence may be performed at a different speed (e.g., accelerated).

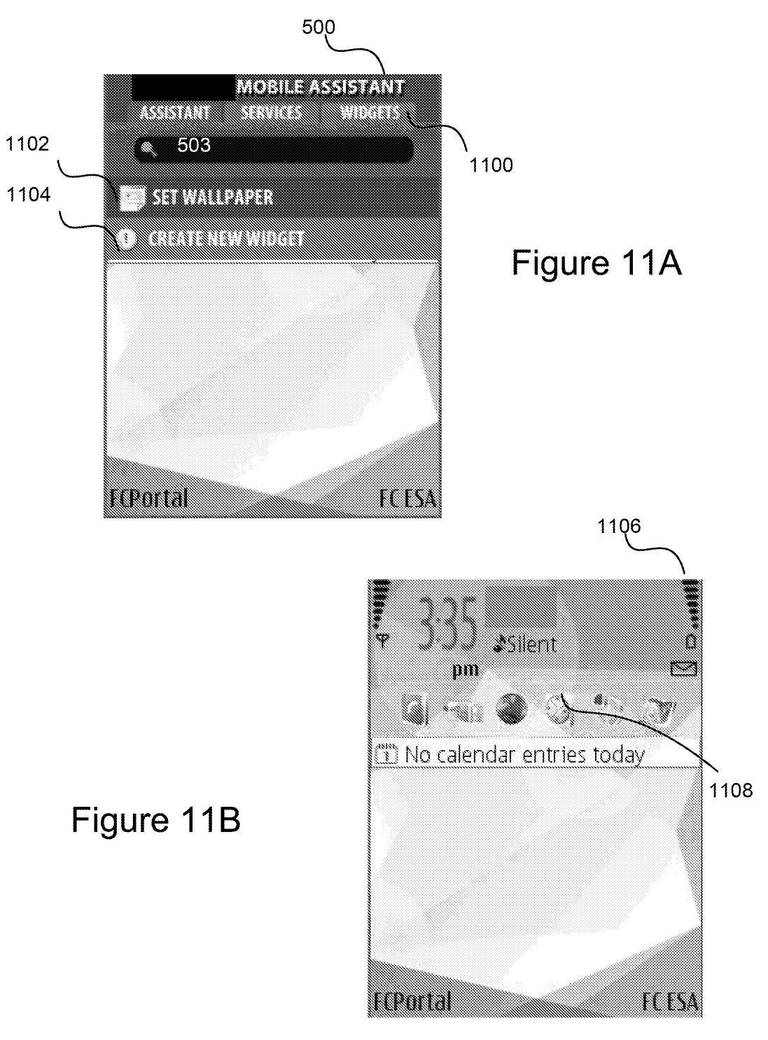

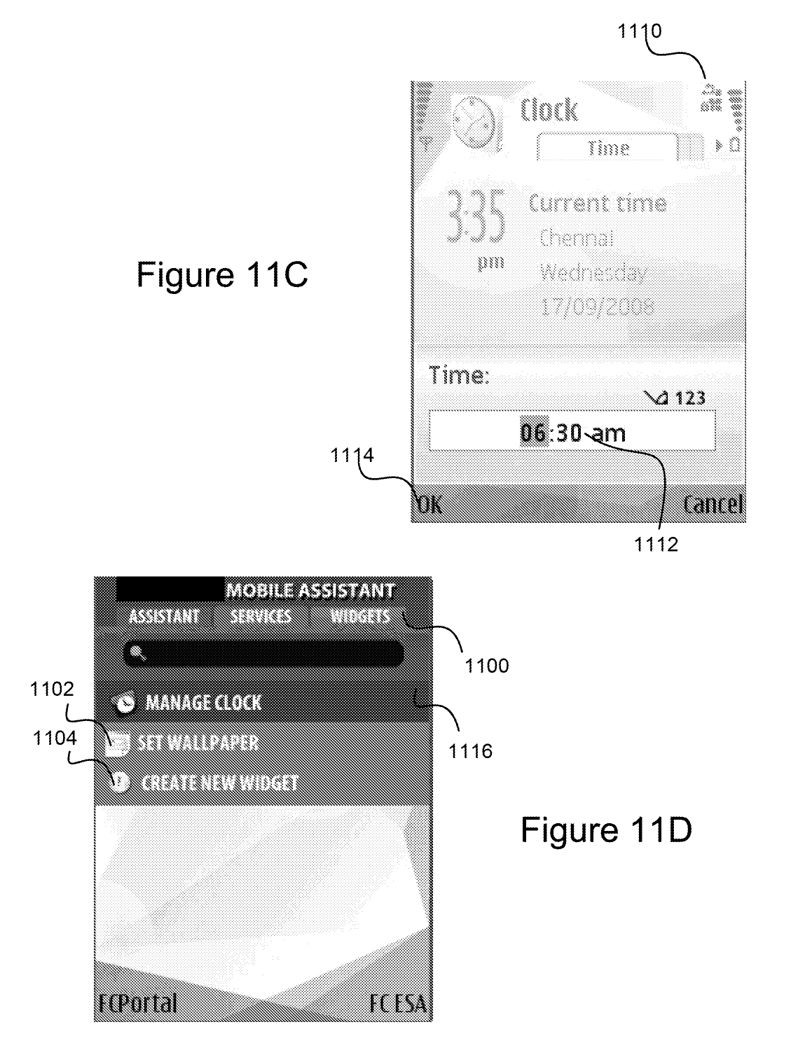

FIGS. 11A-11D illustrate an example of interface activity. In FIG. 11A, a tab 1100 in interface 500 has been selected to invoke a program flow for managing custom definitions, referred to in this example as “widgets.” In this example, text entry field 503 is again shown. However, because tab 1100 has been selected, the mobile assistant interface has presented an option 1102 to use a pre-defined custom definition called “set wallpaper.” Additionally, an option 1104 can be selected to create a new custom definition is shown.

For this example, assume a user desires to define a custom task for setting a clock on the mobile device. Accordingly, the user provides input selecting option 1104. This can, for example, invoke block 1004 of method 1000. In this example, once recording begins, the context of the device is switched to the home screen 1106. The user can provide one or more navigation commands to select icon 1108. For instance, the user may need to provide an “up” command to reach the row of icons and then several “right” or “left” commands to arrive at icon 1108.

FIG. 11C illustrates an interface 1110 for the clock application. The user can continue navigating to the time field to adjust the time. For example, the user may arrive at the hour field (currently displaying “06”) and press “up” or “down” to adjust the time. The user can then provide input indicating that recording is complete and provide a suitable name for the shortcut. As shown at 1116, a “manage clock” option has been added. In the future, the user can utilize the shortcut to recreate the navigation commands to reset the clock automatically. As an example, a user may define two different shortcuts for changing between time zones.

As another example, when defining the “clock” shortcut, the user may end recording before making any adjustments to the time; when the shortcut is used, the navigation commands can then stop once the field for adjusting the time is reached.

In some embodiments, the custom definition manager 310 can support importing and/or exporting shortcuts. For example, the user interface can include a “send” option where one or more shortcuts can be selected and sent to one or more other users using any suitable communication technique (e.g., as an email attachment, SMS payload, etc.). Similarly, custom definition manager 310 can be configured to access predefined shortcuts received at the mobile device, or may browse shortcuts available from one or more remote resources (e.g., from a network service provider or data service provider).

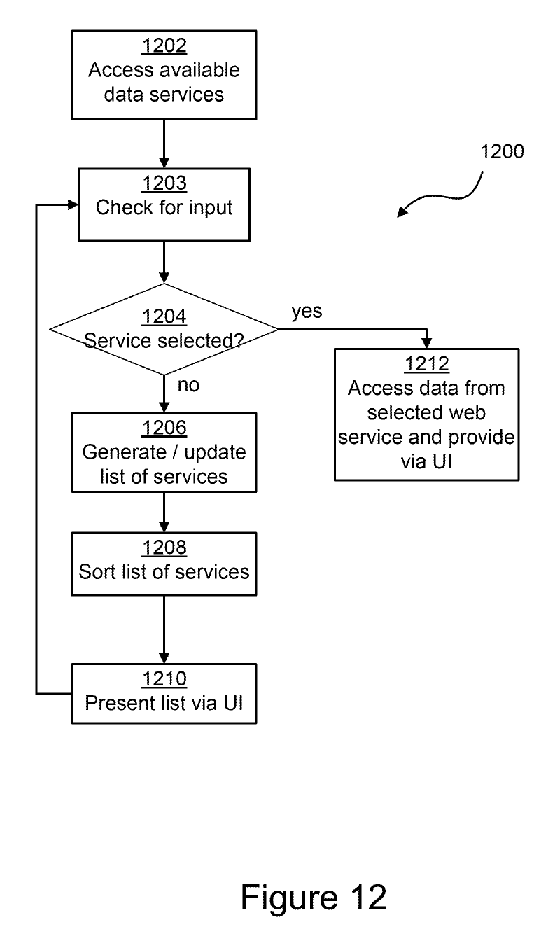

FIG. 12 is a flowchart showing steps in an exemplary method 1200 for providing a data services interface via a mobile assistant. At block 1202, the mobile assistant accesses available data services. For example, user and/or device data maintained at the mobile device may indicate a list of data services to which the device has access. For instance, a list of subscriptions may identify data services by URI (uniform resource indicator) along with user login and password information as needed.

In some embodiments, block 1202 can comprise accessing data from a data service provider 110 and/or a telecommunications provider (e.g., cellular service provider, wireless internet service provider, etc.) that provides communication network 100. For example, relay station 106 may include data or may have access to data indicating a list of subscriptions for a mobile terminal 102. Additionally or alternatively, the list of data services can include data services to which the user may subscribe, but to which no subscription (or other access rights) are available.

At block 1203, the method checks for natural language input and at block 1204, the method determines whether a data service has been selected. If not, at block 1206 a list of services is generated or updated. For instance, the services to which the device has accesses (or may be granted access) can be sorted at block 1208 and then presented via the user interface at 1210.

Natural language input (if any) found at block 1203 may be used in generating block 1206 and sorting block 1208 to narrow down the list of services to present at block 1210. For example, input can be parsed and matched to one or more keywords associated with a data service. If a sufficient match is made between the keyword(s) and the input, the data service can be included in the generated list. If no input is received, the list may comprise any data services subscribed to by the device or otherwise accessible by the device.

Returning to block 1204, if a service is selected, then the selected data service is accessed at block 1212 and provided via the user interface. For example, the mobile assistant can expand to include a preview illustrating some or all of the data that can be accessed from the data service. This can spare a user from needing to access a separate application for the data service when only a quick view of data from the service is needed.

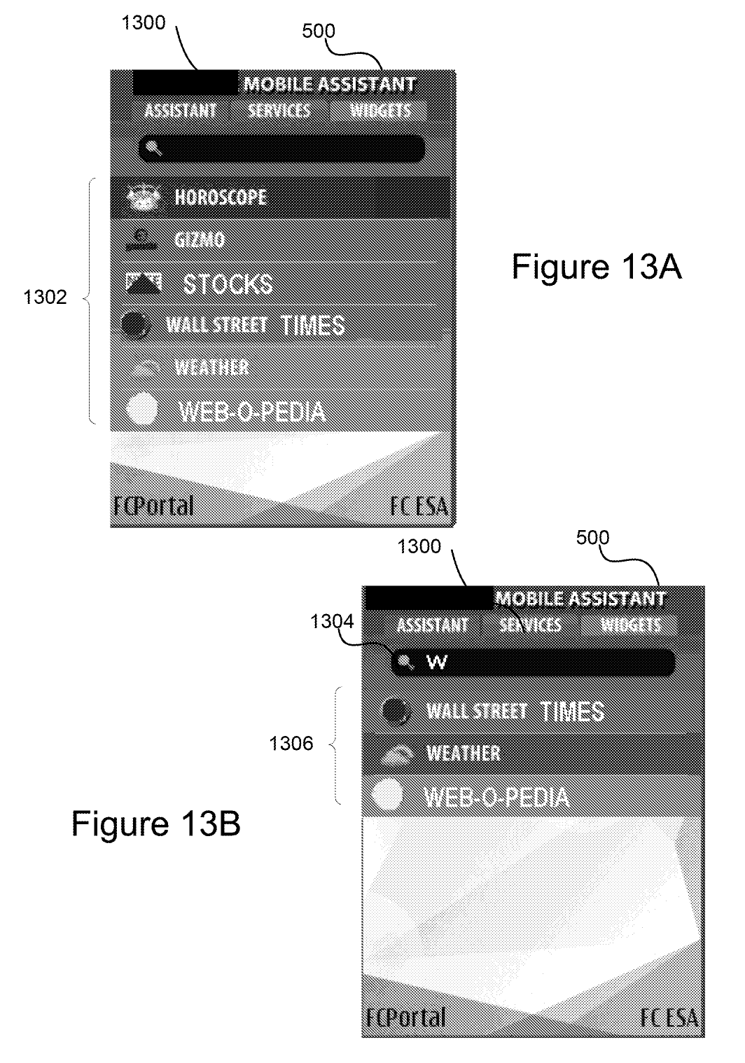

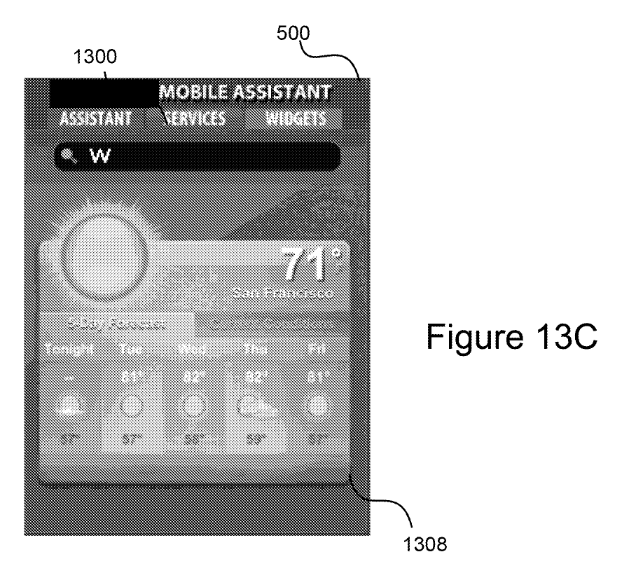

FIGS. 13A-13C illustrate an example of user interface activity when a data services interface of a mobile assistant is utilized. In FIG. 13A, a services tab 1300 has been selected and a list 1302 of available data services is shown. In this example, the services include “horoscope,” “stocks,” “Wall Street Times,” “Weather,” and “Web-o-pedia.” In FIG. 13B, the user has provided input “W” at 1304. An updated list 1306 of services matching the input has been provided. In FIG. 13C, the user has navigated to and selected the “Weather” service. As shown at 1308, weather data for San Francisco, Calif. is displayed.

In some embodiments, the mobile assistant utilizes contextual data in accessing data services. For instance, rather than inputting “w” alone, the user may select or input “Weather” and then continue to provide input. The context of the input can be evaluated against one or more contextual parameters for the service to be invoked and a set of data services with parameters can be generated. For example, the user may input “weather San Jose.” This can be recognized as a command to invoke the Weather service and to pass a parameter such as “city=San Jose” to the service.

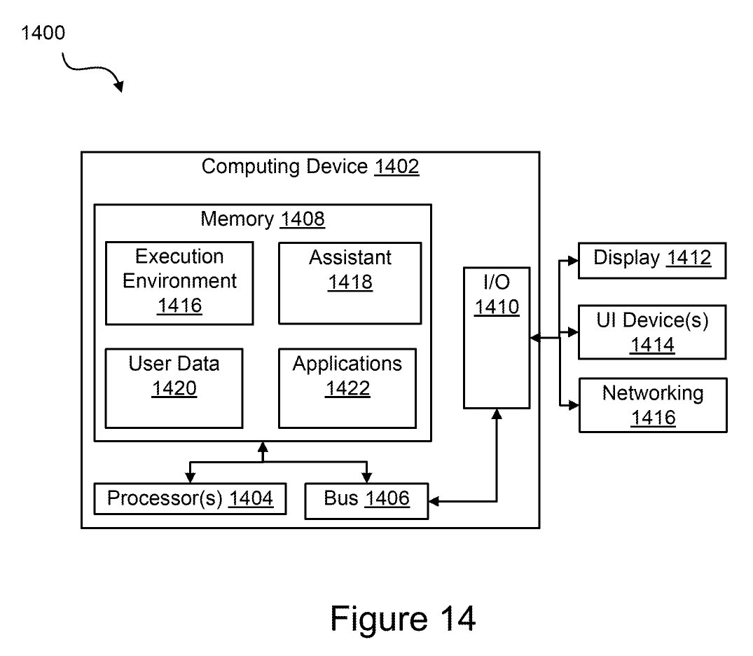

Although several examples were presented above in the context of a mobile terminal, the various systems discussed herein are not limited to any particular hardware architecture or configuration. FIG. 14 is a block diagram illustrating an example of a computing device 1402 that can be configured to utilize an assistant 1418 configured in accordance with one or more aspects of the present subject matter.

In this example, computing device 1402 includes one or more processors 1404, bus 1406, and memory 1408. In addition to assistant 1418, memory 1408 embodies an execution/runtime environment 1416, one or more applications 1422, and user data 1420. Bus 1406 links processor 1404, memory 1408, and I/O interface 1410. I/O interface 1410 may provide connection to a display 1412, one or more user input (UI) devices 1414, and/or additional components, such as a network connection, additional storage device(s), and the like.

In some embodiments, assistant 1418 may find use with computing devices with a menu-driven interface, such as set-top-boxes. Assistant 1418 can be used in addition to or instead of other interfaces, such as point-and-click interfaces. This may be advantageous, for instance, in portable computers with relatively small screen areas (e.g., small laptops and “netbooks”).

Assistant 1418 can be configured to provide some or all of the functionality of a “mobile” assistant discussed above, but in device that is not necessarily a mobile or wireless device, such as by providing a natural language interface for selecting one or more applications 1422, data services available to computing device 1402, and/or defining custom tasks for using computing device 1402 as discussed in the examples above.

### General Considerations

Some portions of the detailed description were presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art.

An algorithm is here and generally is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels.

Unless specifically stated otherwise, as apparent from the foregoing discussion, it is appreciated that throughout this specification discussions utilizing terms such as “processing,” “computing,” “calculating,” “determining” or the like refer to actions or processes of a computing platform, such as one or more computers and/or a similar electronic computing device or devices, that manipulate or transform data represented as physical electronic or magnetic quantities within memories, registers, or other information storage devices, transmission devices, or display devices of the computing platform.

A computing device can include any suitable arrangement of components that provide a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

As noted above, a computing device may access one or more computer-readable media that tangibly embody computer-readable instructions which, when executed by at least one computer, cause the at least one computer to implement one or more embodiments of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Examples of computing devices include, but are not limited to, servers, personal computers, personal digital assistants (PDAs), cellular telephones, televisions, television set-top boxes, and portable music players. Computing devices may be integrated into other devices, e.g. “smart” appliances, automobiles, kiosks, and the like.

The inherent flexibility of computer-based systems allows for a great variety of possible configurations, combinations, and divisions of tasks and functionality between and among components. For instance, processes discussed herein may be implemented using a single computing device or multiple computing devices working in combination. Databases and applications may be implemented on a single system or distributed across multiple systems. Distributed components may operate sequentially or in parallel.

When data is obtained or accessed as between a first and second computer system or components thereof, the actual data may travel between the systems directly or indirectly. For example, if a first computer accesses data from a second computer, the access may involve one or more intermediary computers, proxies, and the like. The actual data may move between the first and second computers, or the first computer may provide a pointer or metafile that the second computer uses to access the actual data from a computer other than the first computer, for instance. Data may be “pulled” via a request, or “pushed” without a request in various embodiments.

The technology referenced herein also makes reference to communicating data between components or systems. It should be appreciated that such communications may occur over any suitable number or type of networks or links, including, but not limited to, a dial-in network, a local area network (LAN), wide area network (WAN), public switched telephone network (PSTN), the Internet, an intranet or any combination of hard-wired and/or wireless communication links.

Any suitable tangible computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A method, comprising:
receiving, by an assistant application executed by a processor of a device, natural language input;
evaluating, by the assistant application, the natural language input to identify a plurality of applications available to the device, wherein the plurality of applications comprise at least one application that is not presented while the natural language input is received;
determining, by the assistant application, a plurality of suggested commands available to the device based on evaluating the natural language input, wherein each command of the plurality of suggested commands is executable by at least one respective application of the plurality of applications, wherein the plurality of suggested commands comprises at least one command for execution by the at least one application that is not presented while the natural language input is received; and
providing, by the assistant application, output at the device comprising at least one suggested command from the plurality of suggested commands.

2. The method set forth in claim 1, further comprising:
in response to selection of a suggested command, invoking one of the plurality of applications corresponding to the selected suggested command.

3. The method set forth in claim 2, further comprising:
prior to invoking one of the plurality of applications corresponding to the selected suggested command:
(i) identifying a context for the one of the plurality of applications corresponding to the selected suggested command, wherein the context comprises at least one of a current application currently being executed at the device or a current interface of the current application; and
(ii) based on the context, outputting a list comprising the suggested command and a suggested parameter value;
wherein invoking the one of the plurality of applications corresponding to the selected suggested command comprises passing the suggested parameter value to the one of the plurality of applications.

4. (canceled)

5. The method set forth in claim 1, wherein the plurality of applications available to the device comprise an application available from a remote resource; and further comprising
in response to selection of a suggested command:
accessing the remote resource,
downloading the application available from the remote resource to the device, and
invoking the application according the suggest command.

6-7. (canceled)

8. The method set forth in claim 1, further comprising:
identifying a plurality of data services accessible via the device;
providing output at the device comprising at least suggested command corresponding to a data service accessible via the device from a remote data provider; and
in response to selection of a suggested command corresponding to a data service, causing the device to access the data service and present data from the data service in a preview interface.

9. The method set forth in claim 1, further comprising:
providing output at the device comprising a shortcut command; and
in response to selection of the shortcut command, accessing a stored sequence of device inputs corresponding to the shortcut command and providing the stored sequence as device inputs.

10. The method set forth in claim 9, further comprising:
providing the stored sequence to a second device.

11. A system comprising:
a processor; and
a non-transitory computer-readable medium communicatively coupled to the processor;
wherein the processor is configured to execute program components tangibly embodied in the non-transitory computer-readable medium to perform operations comprising:
receiving natural language input;
evaluating the natural language input to identify a plurality of applications available to the system, wherein the plurality of applications comprise at least one application that is not presented while the natural language input is received;
determining a plurality of suggested commands available to the system based on evaluating the natural language input, wherein each command of the plurality of suggested commands is executable by at least one respective application of the plurality of applications, wherein the plurality of suggested commands comprises at least one command for execution by the at least one application that is not presented while the natural language input is received; and
providing output comprising at least one suggested command from the plurality of suggested commands.

12. The system set forth in claim 11, wherein the processor is further configured for invoking an application available to the system in response to selection of the at least one suggested command corresponding to the application, wherein invoking the application comprises accessing the application from a remote resource.

13. The system set forth in claim 11, wherein the processor is further configured for invoking an application available to the system in response to selection of the at least one suggested command corresponding to the application, wherein invoking the application comprises executing the application locally.

14. The system set forth in claim 11,
wherein the the processor is further configured for identifying at least one parameter associated with the application and generating a suggested parameter value;
wherein the output comprises at least one suggested command and the suggested parameter value; and
wherein the processor is further configured for invoking an application available to the system in response to selection of the at least one suggested command corresponding to the application, wherein invoking the application comprises passing the suggested parameter value to the application.

15. The system set forth in claim 11, wherein the processor is further configured for:
identifying at least one data service available to the system and generate a list comprising a suggested data service; and
providing a preview of the suggested data service in response to selection of the suggested data service from the list.

16. The system set forth in claim 11, wherein the processor is further configured for:
providing output at the system comprising a shortcut command; and
in response to selection of the shortcut command, accessing a stored sequence of system inputs corresponding to the shortcut command and provide the stored sequence to the system.

17. The system set forth in claim 16, wherein processor is further configured for:
providing an interface to define a new shortcut command;
recording a sequence of inputs; and
storing the sequence of inputs as the new shortcut command.

18. The system set forth in claim 11, wherein the processor and computer- readable medium are comprised in a mobile terminal.

19. The system set forth in claim 11, wherein the processor and computer- readable medium are comprised in a computer, set-top box, or personal digital assistant.

20. A non-transitory computer-readable medium tangibly embodying program code, the program code comprising:
program code for receiving natural language input at a device;
program code for evaluating the natural language input to identify a plurality of applications available to the device, wherein the plurality of applications comprise at least one application that is not presented while the natural language input is received;
program code for determining a plurality of suggested commands available to the device based on evaluating the natural language input, wherein each command of the plurality of suggested commands is executable by at least one respective application of the plurality of applications, wherein the plurality of suggested commands comprises at least one command for execution by the at least one application that is not presented while the natural language input is received;
program code for providing output at the device comprising at least one suggested command from the plurality of suggested commands; and
program code for receiving selection of a suggested command and invoking the resource corresponding to the selected suggested command.

21. The computer-readable medium set forth in claim 20, further comprising:
program code for evaluating a context of the resource corresponding to the selected suggested command and determining a parameter associated with the context; and
program code for determining a suggested parameter value and including the suggested parameter value in the suggested command list.

22. The computer-readable medium set forth in claim 20, wherein the program code for accessing data comprises program code for accessing data from a remote resource and identifying an application available for download to the device from the remote resource.

23. The computer-readable medium set forth in claim 20, further comprising program code for providing a clipboard function, the clipboard function storing data presented at the device while invoking a first resource and accessible at the device while invoking a second resource.

24. The computer-readable medium set forth in claim 23, further comprising program code for determining a suggested parameter value from data stored by the clipboard function, the suggested parameter value determined in response to receipt of the natural language input.

25. (canceled)

26. The method of claim 8, wherein presenting data from the data service in the preview interface comprises presenting the data without executing a separate application for accessing the data service.

27. The method of claim 1, wherein the at least one application that is not presented while the natural language input is received comprises at least one application that is not being executed while the natural language input is received.

28. The method of claim 27, further comprising, prior to providing the output, excluding, by the assistant application, at least some commands from the subset of suggested commands based on a history of suggested commands selected via the device.

29. The method of claim 28, wherein excluding the at least some commands based on the history of suggested commands selected by the device comprises:
determining weights associated with each of the subset of suggested commands based on previous selections of the respective command; and
excluding the at least some commands based on the at least some commands having a lower weight than non-excluded commands.
